(19) United States
(12) Patent Application Publication
(10) Pub. No.: US 2025/0062586 A1
(43) Pub. Date: Feb. 20, 2025

(54) OPTICAL AMPLIFICATION SYSTEM

(71) Applicant: NEC Corporation, Minato-ku, Tokyo (JP)

(72) Inventors: Takeshi TAKEUCHI, Tokyo (JP); Satoshi Mikami, Tokyo (JP)

(73) Assignee: NEC Corporation, Minato-ku, Tokyo (JP)

(21) Appl. No.: 18/721,332

(22) PCT Filed: Mar. 15, 2022
(86) PCT No.: PCT/JP2022/011463

§ 371 Date: Jun. 18, 2024

(51) Int. Cl. H01S 3/10; H01S 3/067; H01S 3/094; H04J 14/02

(52) U.S. Cl. CPC H01S 3/10015; H01S 3/06716; H01S 3/094003; H04J 14/0307

(57) ABSTRACT

An optical amplification system includes: an optical mixer which combined first light, second light, third light, and fourth light, then branches the combined lights, and outputs first combined light, second combined light, third combined light, and fourth combined light; a first brancher that branches the first combined light and outputs first excitation light and second excitation light; a second brancher that branches the second combined light and outputs third excitation light and fourth excitation light; a third brancher that branches the third combined light and outputs fifth excitation light and sixth excitation light; and a fourth brancher that branches the fourth combined light and outputs seventh excitation light and eighth excitation light.

### TECHNICAL FIELD

The present invention relates to, for example, an optical amplification system that amplifies an optical signal.

### BACKGROUND ART

In an optical communication system, an optical amplifier that amplifies an optical signal is used. For the optical amplifier, for example, a fiber-type optical amplifier such as an erbiulll doped fiber amplifier (EDFA) is used. The fiber-type optical amplifier amplifies an optical signal by using excitation light, and therefore the optical communication system requires an optical source that outputs excitation light.

The optical communication system may include a configuration as illustrated in FIG. 8 in such a way as to be capable of amplifying an optical signal even when a part of an optical source fails. As illustrated in FIG. 8, a general optical communication system includes laser diodes (LDs) 100A to 100D, bifurcated optical couplers 200A to 200D, 4MIXs 300A and 300B, and optical amplifiers 400A to 400D.

Each of the LDs 100A to 100D outputs light. Each of the bifurcated optical couplers 200A to 200D splits light output from each of the LDs 100A to 100D into two parts and outputs the split two beams of light to the 4MIXs 300A and 300B. Each of the 4MIXs 300A and 300B includes optical couplers 310 to 340, as illustrated in FIG. 9. The optical coupler 310 splits beams of light from the bifurcated optical couplers 200A and 200B and outputs the split beams of light to the optical couplers 330 and 340. The optical coupler 320 splits beams of light from the bifurcated optical couplers 200C and 200D and outputs the split beams of light to the optical couplers 330 and 340. Thereby, each of the 4MIXs 300A and 300B outputs multiplexed light of beams of light output from the LDs 100A to 100D to the optical amplifier 400A to 400B.

### CITATION LIST

### Patent Literature

PLT 1: International Patent Publication No. WO2019/003797

### SUMMARY OF INVENTION

### Technical Problem

However, when many configurations in which a plurality of optical couplers are mutually connected as in a 4MIX are used, the number of components configuring an optical communication system is increased, and therefore there is a problem in that a configuration is complex.

In view of the above-described problem, an object of the present invention is to provide an optical amplification system being capable of reducing an increase in the number of components.

### Solution to Problem

An optical amplification system according to the present invention includes:

a first optical source that outputs first light;

a second optical source that outputs second light;

a third optical source that outputs third light;

a fourth optical source that outputs fourth light:

an optical mixer that multiplexes the first light, the second light, the third light, and the fourth light, then splits the multiplexed light, and outputs first multiplexed light, second multiplexed light, third multiplexed light, and fourth multiplexed light:

a first branching means for splitting the first multiplexed light and outputting first excitation light and second excitation light:

a second branching means for splitting the second multiplexed light and outputting third excitation light and fourth excitation light:

a third branching means for splitting the third multiplexed light and outputting fifth excitation light and sixth excitation light:

a fourth branching means for splitting the fourth multiplexed light and outputting seventh excitation light and eighth excitation light:

a first amplification means for amplifying a first optical signal by using the first excitation light and amplifying a second optical signal by using the second excitation light:

a second amplification means for amplifying a third optical signal by using the third excitation light and amplifying a fourth optical signal by using the fourth excitation light:

a third amplification means for amplifying a fifth optical signal by using the fifth excitation light and amplifying a sixth optical signal by using the sixth excitation light: and

a fourth amplification means for amplifying a seventh optical signal by using the seventh excitation light and amplifying an eighth optical signal by using the eighth excitation light.

### ADVANTAGEOUS EFFECTS OF INVENTION

According to the present invention, an optical amplification system being capable of reducing an increase in the number of components can be provided.

### BRIEF DESCRIPTION OF DRAWINGS

FIG. 1 is a block diagram illustrating a configuration example of an optical amplification system according to a first example embodiment of the present invention.

FIG. 2 is a diagram illustrating details of the optical amplification system according to the first example embodiment of the present invention.

FIG. 3 is a diagram illustrating details of the optical amplification system according to the first example embodiment of the present invention.

FIG. 4 is a block diagram illustrating a configuration example of an optical amplification system according to a second example embodiment of the present invention.

FIG. 5 is a diagram illustrating details of the optical amplification system according to the second example embodiment of the present invention.

FIG. 6 is a block diagram illustrating a configuration example of an optical amplification system according to a third example embodiment of the present invention.

FIG. 7 is a diagram illustrating details of the optical amplification system according to the third example embodiment of the present invention.

FIG. 8 is a block diagram illustrating a configuration example of a related technique.

FIG. 9 is a diagram illustrating details of the related technique.

### EXAMPLE EMBODIMENT

### First Example Embodiment

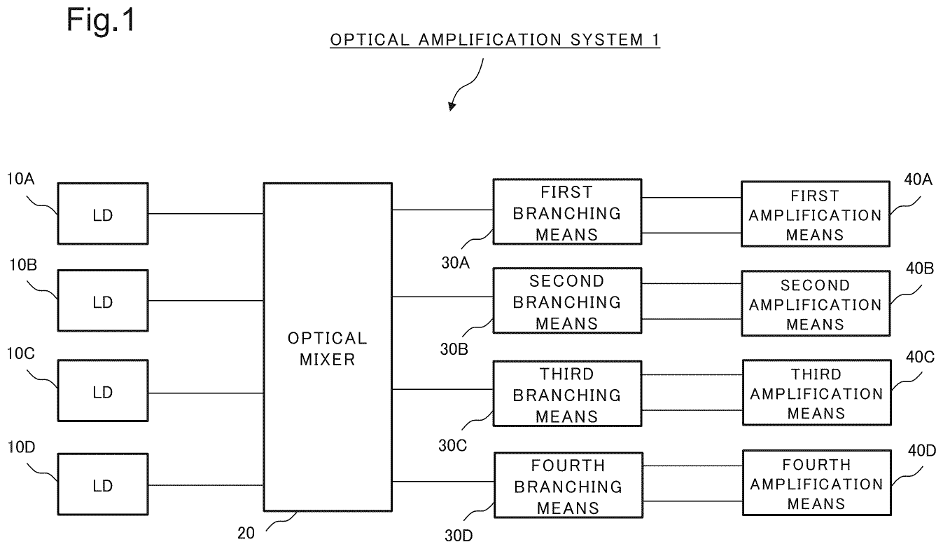

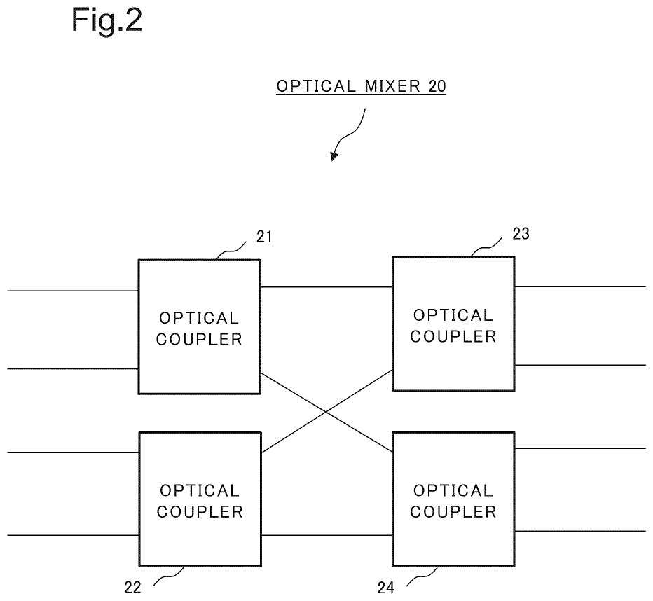

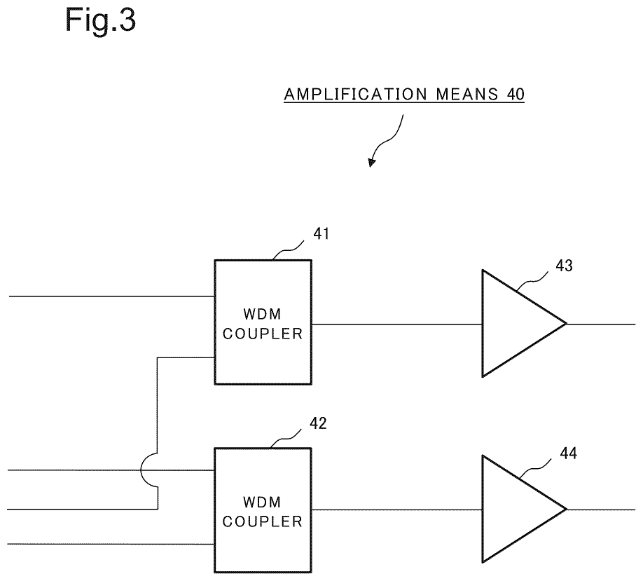

An optical amplification system 1 according to a first example embodiment is described by using FIG. 1, FIG. 2, and FIG. 3. FIG. 1 is a block diagram illustrating a configuration example of the optical amplification system 1. FIG. 2 and FIG. 3 each are a diagram illustrating details of the optical amplification system 1.

As illustrated in FIG. 1, the optical amplification system 1 includes LDs 10A to 10D, an optical mixer 20, a first branching means 30A, a second branching means 30B, a third branching means 30C, a fourth branching means 30D, a first amplification means 40A, a second amplification means 40B, a third amplification means 40C, and a fourth amplification means 40D.

The LDs 10A to 10D are described. When it is unnecessary to discriminate the LDs 10A to 10D each, in the following description, each of the LDs 10A to 10D is referred to as an LD 10. The LD 10A is relevant to a first optical source. The LD 10B is relevant to a second optical source. The LD 10C is relevant to a third optical source. The LD 10D is relevant to a fourth optical source.

The LD 10 is an optical source that outputs light. The LD 10 is connected to the optical mixer 20. The LD 10A outputs first light to the optical mixer 20. The LD 10B outputs second light to the optical mixer 20. The LD 10C outputs third light to the optical mixer 20. The LD 10D outputs fourth light to the optical mixer 20.

The optical mixer 20 is described. The optical mixer 20 is connected to the LDs 10A to 10D and the first branching means 30A to the fourth branching means 30D. The optical mixer 20 multiplexes first light, second light, third light, and fourth light, splits the multiplexed light, and outputs first multiplexed light, second multiplexed light, third multiplexed light, and fourth multiplexed light. Specifically, the optical mixer 20 outputs the first multiplexed light to the first branching means 30A. The optical mixer 20 outputs the second multiplexed light to the second branching means 30B. The optical mixer 20 outputs the third multiplexed light to the third branching means 30C. The optical mixer 20 outputs the fourth multiplexed light to the fourth branching means 30D.

FIG. 2 is a diagram illustrating details of the optical mixer 20. The optical mixer 20 includes optical couplers 21 to 24, as illustrated in FIG. 2. The optical coupler 21 multiplexes first light from the LD 10A and second light from the LD 10B, splits the multiplexed light, and outputs the split beams of light to the optical coupler 23 and the optical coupler 24. The optical coupler 22 multiplexes third light from the LD 10C and fourth light from the LD 10D, splits the multiplexed light, and outputs the split beams of light to the optical coupler 23 and the optical coupler 24.

The optical coupler 23 multiplexes light from the optical coupler 21 and light from the optical coupler 22, splits the multiplexed light, and outputs first multiplexed light to the first branching means 30A and outputs second multiplexed light to the second branching means 30B. The optical coupler 24 multiplexes light from the optical coupler 21 and light from the optical coupler 22, splits the multiplexed light, and outputs third multiplexed light to the third branching means 30C and outputs fourth multiplexed light to the fourth branching means 30D.

The first branching means 30A to the fourth branching means 30D are described. When it is unnecessary to discriminate the first branching means 30A to the fourth branching means 30D each, in the following description, each of the first branching means 30A to the fourth branching means 30D is referred to as a branching means 30. The branching means 30 splits input light and outputs the split beams of light. The branching means 30 is, for example, an optical coupler.

The first branching means 30A is connected to the optical mixer 20 and the first amplification means 40A. The first branching means 30A splits first multiplexed light input from the optical mixer 20 and outputs first excitation light and second excitation light to the first amplification means 40A.

The second branching means 30B is connected to the optical mixer 20 and the second amplification means 40B. The second branching means 30B splits second multiplexed light input from the optical mixer 20 and outputs third excitation light and fourth excitation light to the second amplification means 40B.

The third branching means 30C is connected to the optical mixer 20 and the third amplification means 40C. The third branching means 30C splits third multiplexed light input from the optical mixer 20 and outputs fifth excitation light and sixth excitation light to the third amplification means 40C.

The fourth branching means 30D is connected to the optical mixer 20 and the fourth amplification means 40D. The fourth branching means 30D splits fourth multiplexed light input from the optical mixer 20 and outputs seventh excitation light and eighth excitation light to the fourth amplification means 40D.

The first amplification means 40A to the fourth amplification means 40D are described. When it is unnecessary to discriminate the first amplification means 40A to the fourth amplification means 40D each, in the following description, each of the first amplification means 40A to the fourth amplification means 40D is referred to as an amplification means 40. The amplification means 40 includes an optical amplifier capable of amplifying an optical signal, by using excitation light.

Details of the amplification means 40 are described. FIG. 3 is a block diagram illustrating details of the amplification means 40. As illustrated in FIG. 3, the amplification means 40 includes wavelength division multiplexing (WDM) couplers 41 and 42 and optical amplifiers 43 and 44.

The WDM couplers 41 and 42 are attached with two optical fibers. One of the two optical fibers is an optical fiber through which an optical signal propagates, and the other one is an optical fiber connected to the branching means 30. The WDM couplers 41 and 42 multiplex excitation light from the branching means 30 with an optical signal and output the multiplexed light to the optical amplifiers 43 and 44 each. The optical amplifiers 43 and 44 each amplify an optical signal, by using excitation light. The optical amplifiers 43 and 44 each are, for example, an EDFA.

For example, in the first amplification means 40A, the WDM coupler 41 multiplexes first excitation light from the first branching means 30A with a first optical signal and outputs the multiplexed light to the optical amplifier 43. The optical amplifier 43 amplifies the first optical signal by using the first excitation signal. The WDM coupler 42 multiplexes second excitation light from the first branching means 30A with a second optical signal and outputs the multiplexed light to the optical amplifier 44. The optical amplifier 44 amplifies the second optical signal by using the second excitation signal.

In the second amplification means 40B, the WDM coupler 41 multiplexes third excitation light from the second branching means 30B with a third optical signal and outputs the multiplexed light to the optical amplifier 43. The optical amplifier 43 amplifies the third optical signal by using the third excitation signal. The WDM coupler 42 multiplexes fourth excitation light from the second branching means 30B with a fourth optical signal and outputs the multiplexed light to the optical amplifier 44. The optical amplifier 44 amplifies the fourth optical signal by using the fourth excitation signal.

In the third amplification means 40C, the WDM coupler 41 multiplexes fifth excitation light from the third branching means 30C with a fifth optical signal and outputs the multiplexed light to the optical amplifier 43. The optical amplifier 43 amplifies the fifth optical signal by using the fifth excitation signal. The WDM coupler 42 multiplexes sixth excitation light from the third branching means 30C with a sixth optical signal and outputs the multiplexed light to the optical amplifier 44. The optical amplifier 44 amplifies the sixth optical signal by using the sixth excitation signal.

In the fourth amplification means 40D, the WDM coupler 41 multiplexes seventh excitation light from the fourth branching means 30D with a seventh optical signal and outputs the multiplexed light to the optical amplifier 43. The optical amplifier 43 amplifies the seventh optical signal by using the seventh excitation signal. The WDM coupler 42 multiplexes eighth excitation light from the fourth branching means 30D with an eighth optical signal and outputs the multiplexed light to the optical amplifier 44. The optical amplifier 44 amplifies the eighth optical signal by using the eighth excitation signal.

The above-described first optical signal to eighth optical signal indicate optical signals propagating through optical fibers different from each other.

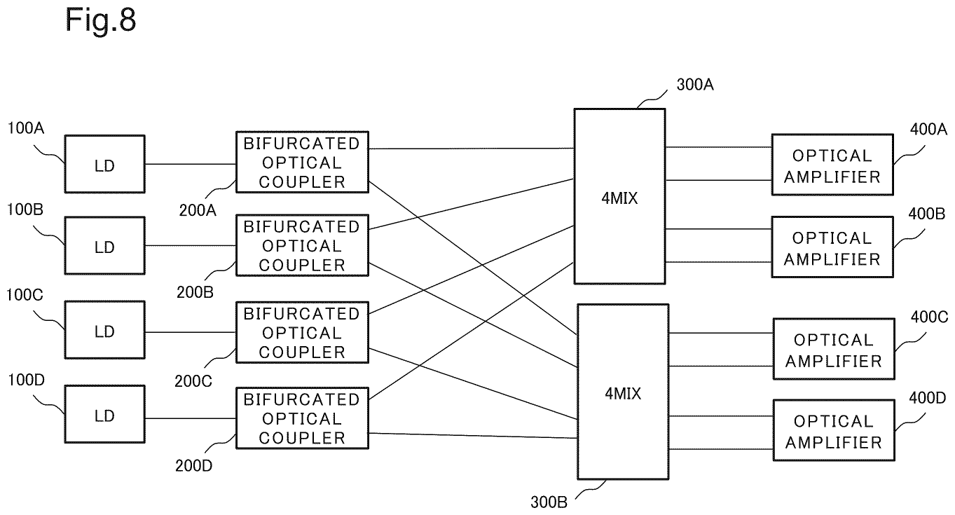

As described above, the optical amplification system 1 has been described. In the configuration illustrated in FIG. 8, light output from an LD is split into two parts and input to two 4MIXs, followed by splitting into four parts, and thereafter eight beams of excitation light are output. In contrast, in the optical amplification system 1, differently from the configuration illustrated in FIG. 8, four beams of light (first to fourth light) are multiplexed by the optical mixer 20 and the multiplexed light is split into four beams of multiplexed light (first multiplexed light to fourth multiplexed light). Thereafter, the branching means 30 further splits the four beams of light, and thereby the optical amplification system 1 outputs eight beams of excitation light. As the 4MIX illustrated in FIG. 8, when many configurations in which a plurality of optical couplers are connected to each other are used, the number of components configuring an optical communication system is increased, and therefore there is a problem in that a configuration is complex. In contrast, in the optical amplification system 1, only one optical mixer including a configuration in which a plurality of optical couplers are connected to each other is used, and therefore compared with the system in FIG. 8 including two 4MIXs, the optical amplification system I can reduce an increase in the number of components and therefore, can be achieved by a simple configuration.

### Second Example Embodiment

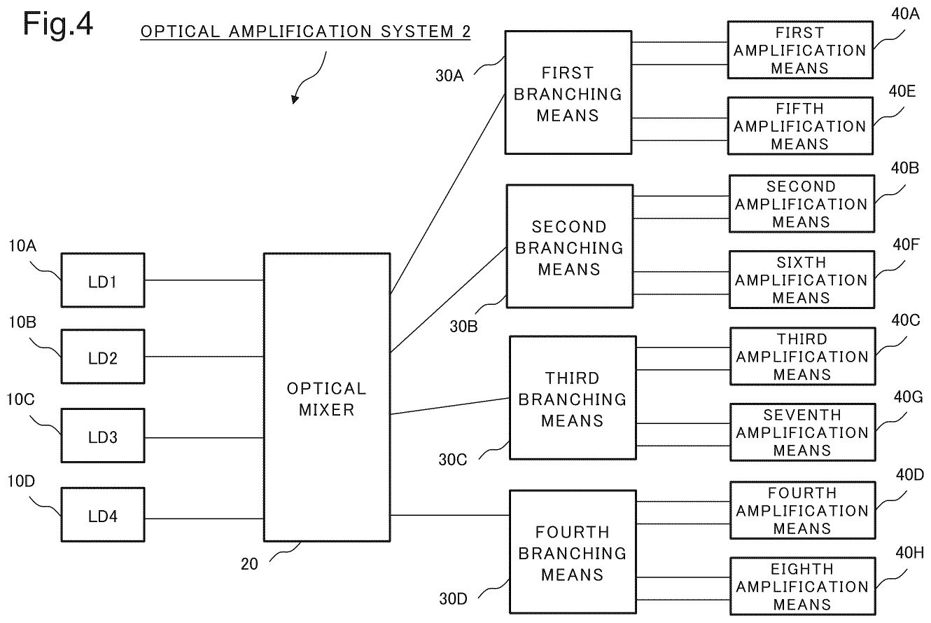

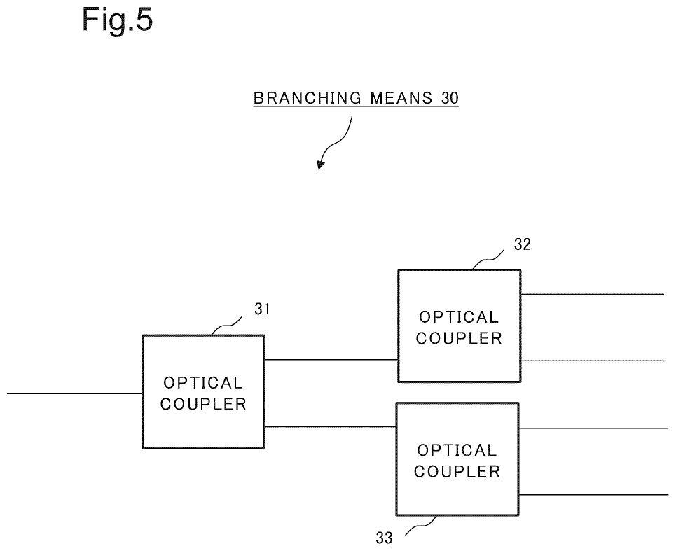

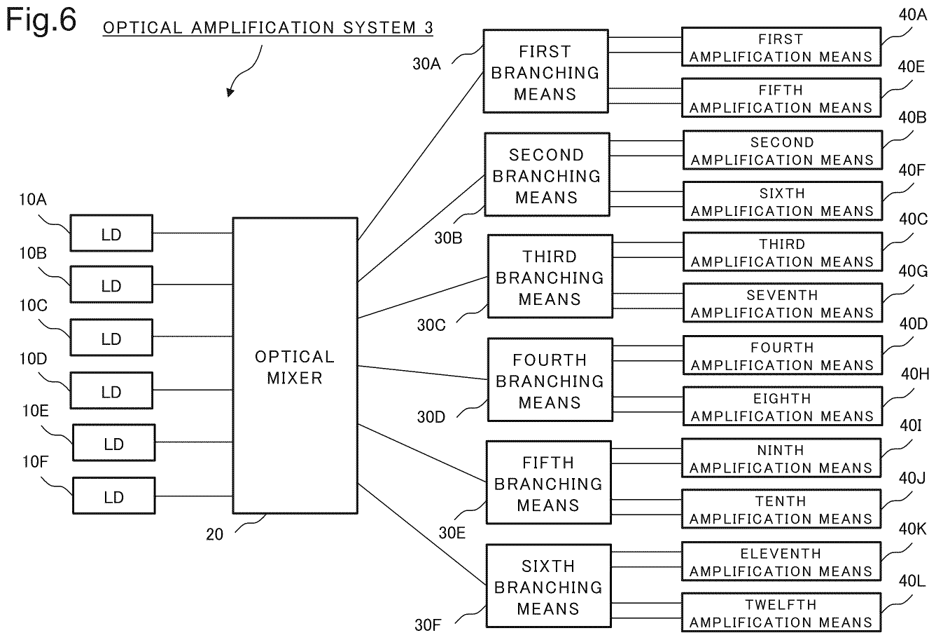

An optical amplification system 2 according to a second example embodiment is described by using FIG. 4, FIG. 5, and FIG. 6. As illustrated in FIG. 4, the optical amplification system 2 includes LDs 10A to 10D, an optical mixer 20, a first branching means 30A, a second branching means 30B, a third branching means 30C, a fourth branching means 30D, a first amplification means 40A, a second amplification means 40B, a third amplification means 40C, a fourth amplification means 40D, a fifth amplification means 40E, a sixth amplification means 40F, a seventh amplification means 40G, and an eighth amplification means 40H.

The optical amplification system 2 is different from the optical amplification system 1 in that the fifth amplification means 40E, the sixth amplification means 40F, the seventh amplification means 40G, and the eighth amplification means 40H are further included. When it is unnecessary to discriminate the first amplification means 40A to the eighth amplification means 40H each, in the following description, each of the first amplification means 40A to the eighth amplification means 40H is referred to as an amplification means 40.

An optical branching means 30 in the optical amplification system 2 is described. FIG. 5 is a block diagram illustrating a configuration example of the optical branching means 30 in the optical amplification system 2. As illustrated in FIG. 5, the branching means 30 includes optical couplers 31 to 33.

The optical coupler 31 splits multiplexed light input from the optical mixer 20 and outputs the split beams of light to the optical coupler 32 and the optical coupler 33. The multiplexed light input from the optical mixer 20 is any one of first multiplexed light, second multiplexed light, third multiplexed light, and fourth multiplexed light. Each of the optical coupler 32 and the optical coupler 33 splits input light and outputs excitation light to two amplification means.

Specifically, in the first branching means 30A, the optical coupler 31 splits, based on the optical coupler 31, first multiplexed light input from the optical mixer 20 and outputs the split beams of light to the optical coupler 32 and the optical coupler 33. The optical coupler 32 further splits light input from the optical coupler 31 and outputs first excitation light and second excitation light to the first amplification means 40A. The optical coupler 33 further splits light input from the optical coupler 31 and outputs ninth excitation light and tenth excitation light to the fifth amplification means 40E.

In the second branching means 30B, the optical coupler 31 splits, based on the optical coupler 31, second multiplexed light input from the optical mixer 20 and outputs the split beams of light to the optical coupler 32 and the optical coupler 33. The optical coupler 32 further splits light input from the optical coupler 31 and outputs third excitation light and fourth excitation light to the second amplification means 40B. The optical coupler 33 further splits light input from the optical coupler 31 and outputs eleventh excitation light and twelfth excitation light to the fifth amplification means 40F.

In the third branching means 30C, the optical coupler 31 splits, based on the optical coupler 31, third multiplexed light input from the optical mixer 20 and outputs the split beams of light to the optical coupler 32 and the optical coupler 33. The optical coupler 32 further splits light input from the optical coupler 31 and outputs fifth excitation light and sixth excitation light to the third amplification means 40C. The optical coupler 33 further splits light input from the optical coupler 31 and outputs thirteenth excitation light and fourteenth excitation light to the seventh amplification means 40G.

In the fourth branching means 30D, the optical coupler 31 splits, based on the optical coupler 31, third multiplexed light input from the optical mixer 20 and outputs the split beams of light to the optical coupler 32 and the optical coupler 33. The optical coupler 32 further splits light input from the optical coupler 31 and outputs seventh excitation light and eighth excitation light to the fourth amplification means 40D. The optical coupler 33 further splits light input from the optical coupler 31 and outputs fifteenth excitation light and sixteenth excitation light to the eighth amplification means 40H.

The fifth amplification means 40E, the sixth amplification means 40F, the seventh amplification means 40G, and the eighth amplification means 40H are described. Each of the fifth amplification means 40E, the sixth amplification means 40F, the seventh amplification means 40G, and the eighth amplification means 40H includes the configuration illustrated in FIG. 3, similarly to each of the first amplification means 40A to the fourth amplification means 40D. Specifically, each of the fifth amplification means 40E, the sixth amplification means 40F, the seventh amplification means 40G, and the eighth amplification means 40H includes the WDM couplers 41 and 42 and the optical amplifiers 43 and 44.

For example, in the fifth amplification means 40E, the WDM coupler 41 multiplexes ninth excitation light from the first branching means 30A with a ninth optical signal and outputs the multiplexed light to the optical amplifier 43. The optical amplifier 43 amplifies the ninth optical signal by using the ninth excitation light. The WDM coupler 42 multiplexes tenth excitation light from the first branching means 30A with a tenth optical signal and outputs the multiplexed light to the optical amplifier 44. The optical amplifier 44 amplifies the tenth optical signal by using the tenth excitation light.

In the sixth amplification means 40F, the WDM coupler 41 multiplexes eleventh excitation light from the second branching means 30B with an eleventh optical signal and outputs the multiplexed light to the optical amplifier 43. The optical amplifier 43 amplifies the eleventh optical signal by using the eleventh excitation light. The WDM coupler 42 multiplexes twelfth excitation light from the second branching means 30B with a twelfth optical signal and outputs the multiplexed light to the optical amplifier 44. The optical amplifier 44 amplifies the twelfth optical signal by using the twelfth excitation light.

In the seventh amplification means 40G, the WDM coupler 41 multiplexes thirteenth excitation light from the third branching means 30C with a thirteenth optical signal and outputs the multiplexed light to the optical amplifier 43. The optical amplifier 43 amplifies the thirteenth optical signal by using the thirteenth excitation light. The WDM coupler 42 multiplexes fourteenth excitation light from the third branching means 30C with a fourteenth optical signal and outputs the multiplexed light to the optical amplifier 44. The optical amplifier 44 amplifies the fourteenth optical signal by using the fourteenth excitation light.

In the eighth amplification means 40H, the WDM coupler 41 multiplexes fifteenth excitation light from the fourth branching means 30D with a fifteenth optical signal and outputs the multiplexed light to the optical amplifier 43. The optical amplifier 43 amplifies the fifteenth optical signal by using the fifteenth excitation light. The WDM coupler 42 multiplexes sixteenth excitation light from the fourth branching means 30D with a sixteenth optical signal and outputs the multiplexed light to the optical amplifier 44. The optical amplifier 44 amplifies the sixteenth optical signal by using the sixteenth excitation light.

The above-described first optical signal to sixteenth optical signal indicate optical signals propagating through optical fibers different from each other.

As described above, the optical amplification system 2 has been described. The optical amplification system 2 includes a configuration similar to the optical amplification system 1. Therefore, also in the optical amplification system 2, only one optical mixer including a configuration in which a plurality of optical couplers are connected to each other is used. As a result, compared with the system in FIG. 8 including two 4MIXs, the optical amplification system 2 can reduce an increase in the number of components and therefore, can be achieved by a simple configuration. The optical amplification system 2 further includes the fifth amplification means 40E to the eighth amplification means 40H, and therefore compared with the optical amplification system 1, many optical signals can be amplified.

### Third Example Embodiment

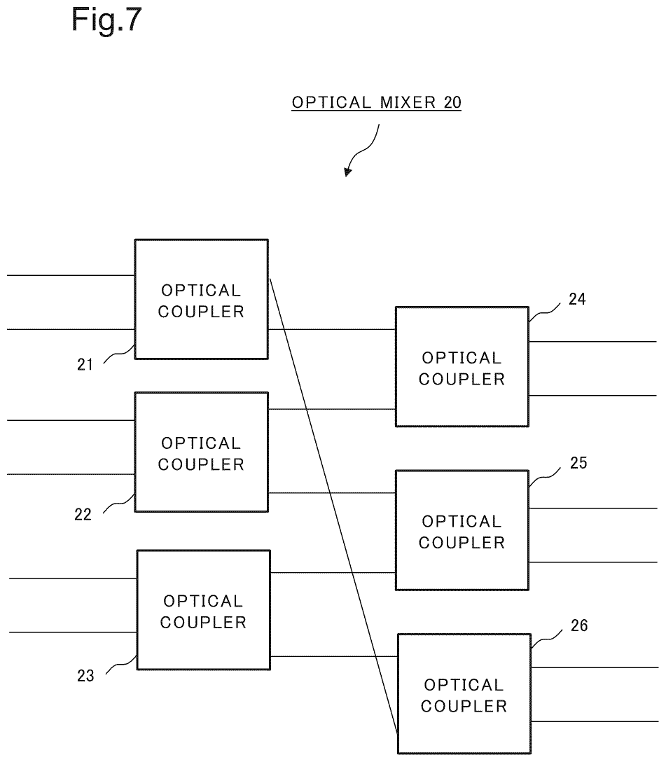

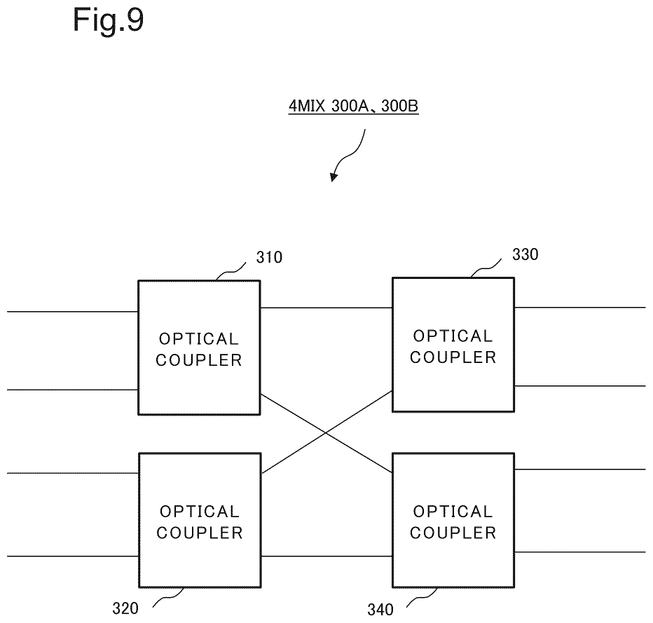

An optical amplification system 3 according to a third example embodiment is described by using FIG. 7, FIG. 8, and FIG. 9. As illustrated in FIG. 7, the optical amplification system 3 includes LDs 10A to 10D, an optical mixer 20, a first branching means 30A, a second branching means 30B, a third branching means 30C, a fourth branching means 30D, a fifth branching means 30E, a sixth branching means 30F, a first amplification means 40A, a second amplification means 40B, a third amplification means 40C, a fourth amplification means 40D, a fifth amplification means 40E, a sixth amplification means 40F, a seventh amplification means 40G, an eighth amplification means 40H, a ninth amplification means 401, a tenth amplification means 40J, an eleventh amplification means 40K, and a twelfth amplification means 40L.

The optical amplification system 3 is different from the optical amplification system 2 in that the LD 10E, the LD 10F, the fifth branching means 30E, the sixth branching means 30F, the ninth amplification means 40I, the tenth amplification means 40J, the eleventh amplification means 40K, and the twelfth amplification means 40L are further included.

When it is unnecessary to discriminate the LD 10A to the LD 10F each, in the following description, each of the 10A to the LD 10F is referred to as an LD 10. When it is unnecessary to discriminate the first branching means 30A to the sixth branching means 30F each, in the following description, each of the first branching means 30A to the sixth branching means 30F is referred to as a branching means 30. When it is unnecessary to discriminate the first amplification means 40A to the twelfth amplification means 40L each, in the following description, each of the first amplification means 40A to the twelfth amplification means 40L is referred to as an amplification means 40.

The LD 10E and the LD 10F each are an optical source that outputs light. The LD 10E and the LD 10F are connected to the optical mixer 20. The LD 10E outputs fifth light to the optical mixer 20. The LD 10F outputs sixth light to the optical mixer 20. The LD 10E is relevant to a fifth optical source. The LD 10F is relevant to a sixth optical source.

The optical mixer 20 in the optical amplification system 3 is described. The optical mixer 20 multiplexes some of first light, second light, third light, fourth light, fifth light, and sixth light with each other and splits the multiplexed light. The optical mixer 20 outputs first multiplexed light, second multiplexed light, third multiplexed light, fourth multiplexed light, fifth multiplexed light, and sixth multiplexed light.

FIG. 8 is a block diagram illustrating a configuration example of the optical mixer 20 in the optical amplification system 3. As illustrated in FIG. 8, the optical mixer 20 includes optical couplers 21 to 26.

First light from the LD 10A and second light from the LD 10B are input to the optical coupler 21. The optical coupler 21 multiplexes the first light and the second light, splits the multiplexed light, and outputs the split beams of light to the optical coupler 24 and the optical coupler 26.

Third light from the LD 10C and fourth light from the LD 10D are input to the optical coupler 22. The optical coupler 22 multiplexes the third light and the fourth light, splits the multiplexed light, and outputs the split beams of light to the optical coupler 24 and the optical coupler 25.

Fifth light from the LD 10E and sixth light from the LD 10F are input to the optical coupler 23. The optical coupler 23 multiplexes the fifth light and the sixth light, splits the multiplexed light, and outputs the split beams of light to the optical coupler 24 and the optical coupler 26.

Light from the optical coupler 21 and light from the optical coupler 22 are input to the optical coupler 24. The optical coupler 24 multiplexes the input beams of light, splits the multiplexed light, and outputs first multiplexed light to the first branching means 30A and outputs second multiplexed light to the second branching means 30B.

Light from the optical coupler 22 and light from the optical coupler 23 are input to the optical coupler 25. The optical coupler 25 multiplexes the input beams of light, splits the multiplexed light, and outputs third multiplexed light to the third branching means 30C and outputs fourth multiplexed light to the fourth branching means 30D.

Light from the optical coupler 21 and light from the optical coupler 23 are input to the optical coupler 26. The optical coupler 26 multiplexes the input beams of light, splits the multiplexed light, and outputs fifth multiplexed light to the fifth branching means 30E and outputs sixth multiplexed light to the sixth branching means 30F.

The branching means 30 in the optical amplification system 3 is described. The branching means 30 in the optical amplification system 3 includes a configuration similar to the branching means 30 in the optical amplification system 2. Specifically, the branching means 30 includes optical couplers 31 to 33, as illustrated in FIG. 5.

Specifically, in the fifth branching means 30E, the optical coupler 31 splits, based on the optical coupler 31, fifth multiplexed light input from the optical mixer 20 and outputs the split beams of light to the optical coupler 32 and the optical coupler 33. The optical coupler 32 further splits light input from the optical coupler 31 and outputs seventeenth excitation light and eighteenth excitation light to the ninth amplification means 401. The optical coupler 33 further splits light input from the optical coupler 31 and outputs nineteenth excitation light and twentieth excitation light to the tenth amplification means 40J.

In the sixth branching means 30F, the optical coupler 31 splits, based on the optical coupler 31, sixth multiplexed light input from the optical mixer 20 and outputs the split beams of light to the optical coupler 32 and the optical coupler 33. The optical coupler 32 further splits light input from the optical coupler 31 and outputs twenty-first excitation light and twenty-second excitation light to the eleventh amplification means 40K. The optical coupler 33 further splits light input from the optical coupler 31 and outputs twenty-third excitation light and twenty-fourth excitation light to the twelfth amplification means 40L.

The ninth amplification means 401, the tenth amplification means 40J, the eleventh amplification means 40K, and the twelfth amplification means 40L are described. Each of the ninth amplification means 401, the tenth amplification means 40J, the eleventh amplification means 40K, and the twelfth amplification means 40L includes the configuration illustrated in FIG. 3, similarly to each of the first amplification means 40A to the eighth amplification means 40H. Specifically, each of the ninth amplification means 401, the tenth amplification means 40J, the eleventh amplification means 40K, and the twelfth amplification means 40L includes the WDM couplers 41 and 42 and the optical amplifiers 43 and 44.

For example, in the ninth amplification means 401, the WDM coupler 41 multiplexes seventeenth excitation light from the fifth branching means 30E with a seventeenth optical signal and outputs the multiplexed light to the optical amplifier 43. The optical amplifier 43 amplifies the seventeenth optical signal, by using the seventeenth excitation light. The WDM coupler 42 multiplexes eighteenth excitation light from the fifth branching means 30E with an eighteenth optical signal and outputs the multiplexed light to the optical amplifier 44. The optical amplifier 44 amplifies the eighteenth optical signal, by using the eighteenth excitation light.

In the tenth amplification means 40J, the WDM coupler 41 multiplexes nineteenth excitation light from the fifth branching means 30E with a nineteenth optical signal and outputs the multiplexed light to the optical amplifier 43. The optical amplifier 43 amplifies the nineteenth optical signal, by using the nineteenth excitation light. The WDM coupler 42 multiplexes twentieth excitation light from the fifth branching means 30E with a twentieth optical signal and outputs the multiplexed light to the optical amplifier 44. The optical amplifier 44 amplifies the twentieth optical signal, by using the twentieth excitation light.

For example, in the eleventh amplification means 40K, the WDM coupler 41 multiplexes twenty-first excitation light from the sixth branching means 30F with a twenty-first optical signal and outputs the multiplexed light to the optical amplifier 43. The optical amplifier 43 amplifies the twenty-first optical signal, by using the twenty-first excitation light. The WDM coupler 42 multiplexes twenty-second excitation light from the sixth branching means 30F with a twenty-second optical signal and outputs the multiplexed light to the optical amplifier 44. The optical amplifier 44 amplifies the twenty-second optical signal, by using the twenty-second excitation light.

In the twelfth amplification means 40L, the WDM coupler 41 multiplexes twenty-third excitation light from the sixth branching means 30F with a twenty-third optical signal and outputs the multiplexed light to the optical amplifier 43. The optical amplifier 43 amplifies the twenty-third optical signal, by using the twenty-third excitation light. The WDM coupler 42 multiplexes twenty-fourth excitation light from the sixth branching means 30F with a twenty-fourth optical signal and outputs the multiplexed light to the optical amplifier 44. The optical amplifier 44 amplifies the twenty-fourth optical signal, by using the twenty-fourth excitation light.

The above-described first optical signal to twenty-fourth optical signal indicate optical signals propagating through optical fibers different from each other.

As described above, the optical amplification system 3 has been described. The optical amplification system 3 includes a configuration similar to the optical amplification systems 1 and 2. Therefore, also in the optical amplification system 3, only one optical mixer including a configuration in which a plurality of optical couplers are connected to each other is used. As a result, compared with the system in FIG. 8 including two 4MIXs, the optical amplification system 3 can reduce an increase in the number of components and therefore, can be achieved by a simple configuration. The optical amplification system 3 further includes the ninth amplification means 401 to the twelfth amplification means 40L, and therefore, compared with the optical amplification systems 1 and 2, many optical signals can be amplified.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

### Reference Signs List

1, 2, 3 Optical amplification system
10, 10A, 10B, 10C, 10D, 10E, 10F LD
20 Optical mixer
21, 22, 23, 24, 25, 26 Optical coupler
30 Branching means
30A First branching means
30B Second branching means
30C Third branching means
30D Fourth branching means
30E Fifth branching means
30F Sixth branching means
31, 32, 33 Optical coupler
40 Amplification means
40A First amplification means
40B Second amplification means
40C Third amplification means
40D Fourth amplification means
40E Fifth amplification means
40F Sixth amplification means
40G Seventh amplification means
40H Eighth amplification means
40I Ninth amplification means
40J Tenth amplification means
40K Eleventh amplification means
40L Twelfth amplification means
41, 42 WDM coupler
43, 44 Optical amplifier

What is claimed is:

1. An optical amplification system comprising:
a first optical source that outputs first light;
a second optical source that outputs second light;
a third optical source that outputs third light;
a fourth optical source that outputs fourth light;
an optical mixer that multiplexes the first light, the second light, the third light, and the fourth light, then splits the multiplexed light, and outputs first multiplexed light, second multiplexed light, third multiplexed light, and fourth multiplexed light;
a first brancher that splits the first multiplexed light and outputs first excitation light and second excitation light;
a second brancher that splits the second multiplexed light and outputs third excitation light and fourth excitation light;
a third brancher that splits the third multiplexed light and outputting outputs fifth excitation light and sixth excitation light;
a fourth brancher that splits the fourth multiplexed light and outputs seventh excitation light and eighth excitation light;
a first amplifier that amplifies a first optical signal by using the first excitation light and amplifies a second optical signal by using the second excitation light;
a second amplifier that amplifies a third optical signal by using the third excitation light and amplifies a fourth optical signal by using the fourth excitation light;
a third amplifier that amplifies a fifth optical signal by using the fifth excitation light and amplifies a sixth optical signal by using the sixth excitation light; and
a fourth amplifier that amplifies a seventh optical signal by using the seventh excitation light and amplifies an eighth optical signal by using the eighth excitation light.

2. The optical amplification system according to claim 1, further comprising
a fifth amplifier; a sixth amplifier; a seventh amplifier; and an eighth amplifier, wherein
the first brancher splits the first multiplexed light and outputs the first excitation light, the second excitation light, ninth excitation light, and tenth excitation light,
the second brancher splits the second multiplexed light and outputs the third excitation light, the fourth excitation light, eleventh excitation light, and twelfth excitation light,
the third brancher splits the third multiplexed light and outputs the fifth excitation light, the sixth excitation light, thirteenth excitation light, and fourteenth excitation light,
the fourth brancher splits the fourth multiplexed light and outputs the seventh excitation light, the eighth excitation light, fifteenth excitation light, and sixteenth excitation light,
the fifth amplifier means amplifies a ninth optical signal by using the ninth excitation light and amplifies a tenth optical signal by using the tenth excitation light,
the sixth amplifier amplifies an eleventh optical signal by using the eleventh excitation light and amplifies a twelfth optical signal by using the twelfth excitation light,
the seventh amplifier amplifies a thirteenth optical signal by using the thirteenth excitation light and amplifies a fourteenth optical signal by using the fourteenth excitation light, and
the eighth amplifier amplifies a fifteenth optical signal by using the fifteenth excitation light and amplifies a sixteenth optical signal by using the sixteenth excitation light.

3. The optical amplification system according to claim 2, further comprising:
a fifth optical source that outputs fifth light;
a sixth optical source that outputs sixth light;
a fifth brancher; a sixth brancher; a ninth amplifier; a tenth amplifier; an eleventh amplifier; and a twelfth amplifier, wherein
the optical mixer multiplexes some of the first light, the second light, the third light, the fourth light, the fifth light, and sixth light with each other, then splits the multiplexed light, and outputs the first multiplexed light, the second multiplexed light, the third multiplexed light, the fourth multiplexed light, fifth multiplexed light, and sixth multiplexed light,
the fifth brancher splits the fifth multiplexed light and outputs seventeenth excitation light, eighteenth excitation light, nineteenth excitation light, and twentieth excitation light,
the sixth brancher splits the sixth multiplexed light and outputs twenty-first excitation light, twenty-second excitation light, twenty-third excitation light, and twenty-fourth excitation light,
the ninth amplifier amplifies a seventeenth optical signal by using the seventeenth excitation light and amplifies an eighteenth optical signal by using the eighteenth excitation light,
the tenth amplifier amplifies a nineteenth optical signal by using the nineteenth excitation light and amplifies a twentieth optical signal by using the twentieth excitation light,
the eleventh amplifier amplifies a twenty-first optical signal by using the twenty-first excitation light and amplifies a twenty-second optical signal by using the twenty-second excitation light, and
the twelfth amplifier amplifies a twenty-third optical signal by using the twenty-third excitation light and amplifies a twenty-fourth optical signal by using the twenty-fourth excitation light.
